(19) United States
(12) Patent Application Publication
(10) Pub. No.: US 2024/0425299 A1
(43) Pub. Date: Dec. 26, 2024

(54) ARTICLE SUPPLY APPARATUS

(71) Applicant: BANDAI CO., LTD., Tokyo (JP)

(72) Inventors: Hajime KONDO, Tokyo (JP); Tatsushi IKARASHI, Tokyo (JP); Nobuo KUROKAWA, Tokyo (JP)

(21) Appl. No.: 18/751,196

(22) Filed: Jun. 22, 2024

(30) Foreign Application Priority Data
Jun. 22, 2023 (JP) 2023-102654

(51) Int. Cl. B65G 47/80; B65G 47/14

(52) U.S. Cl. CPC B65G 47/80; B65G 47/1457; B65G 2812/14

(57) ABSTRACT

An article supply apparatus comprises a main body, an article accommodating unit provided in the main body, accommodates articles, an article supply unit provided in the article accommodating unit and including a first turntable and a second turntable, and a first operating unit provided in the article supply unit, wherein a relative position of the second turntable with respect to the first turntable is changed by an operation of the first operating unit.

### CROSS-REFERENCE TO RELATED APPLICATIONS

The disclosure of Japanese Patent Application No. 2023-102654 filed on Jun. 22, 2023 including specification, drawings and claims is incorporated herein by reference in its entirety.

### TECHNICAL FIELD

The present invention relates to an article supply apparatus.

### BACKGROUND

As disclosed in, for example, Japanese Patent Application Publication No. 2007-34603, conventionally, a box-shaped main body, which is provided in an article supply apparatus, such as an automatic vending machine, accommodates a large number of sealed capsule articles. In the box-shaped body, a drum-shaped article holding unit is provided. The article holding unit has a plurality of article holding holes, in each of which one capsule article may be held. When the article holding unit is rotated, one of the capsule articles accommodated in the box-shaped main body is discharged therefrom.

### SUMMARY

### Technical Problem

In the article supply apparatus disclosed in Japanese Patent Application Publication No. 2007-34603, the capsule articles, which are held by the rotating article holding member and are discharged one by one, have the same outer diameter size. In other words, there is a limitation on the size of the capsule articles handled by the article supply apparatus (automatic vending machine), so that there is a problem that it lacks versatility as to article supply.

It is an object of the present invention to provide an article supply apparatus in which the versatility is improved.

### Solution to Problem

One of the aspects of an embodiment of the present invention is an article supply apparatus. The article supply apparatus includes a main body, an article accommodating unit provided in the main body to accommodate articles, an article supply unit, which is provided in the article accommodating unit and includes a first turntable and a second turntable, and a first operation part provided in the article supply unit, wherein the second turntable is configured to change the relative position of the second turntable with respect to the first turntable by operating the first operating unit.

### Advantageous Effect of Invention

According to the present invention, it is possible to provide an article supply apparatus in which the versatility is improved.

### BRIEF DESCRIPTION OF DRAWINGS

FIG. 1 is a perspective view showing an external appearance of an article supply apparatus according to an embodiment of the present invention;

FIG. 2 is a vertical sectional view of the article supply apparatus shown in FIG. 1, taken along a front-rear direction thereof;

FIG. 3 is a perspective view of the article supply apparatus shown in FIG. 1, wherein the article accommodating unit is detached from the article supply apparatus;

FIG. 4 is a perspective view of the article accommodating unit showing the inside thereof;

FIG. 5 is a schematic plan view of a turntable of the article supply apparatus viewed from above;

FIG. 6 is a plan view of a second turntable of the article supply apparatus viewed from above;

FIG. 7 is a schematic plan view of the turntable of the article supply unit, showing article holding holes in a minimum open state;

FIG. 8 is an enlarged perspective view of a first operation part and an elongated hole wherein part of the first turntable is removed; and

FIG. 9 is an enlarged perspective view of a first hole portion and a second hole portion, wherein the first hole portion and the second hole portion are overlapped each other.

### DETAILED DESCRIPTION

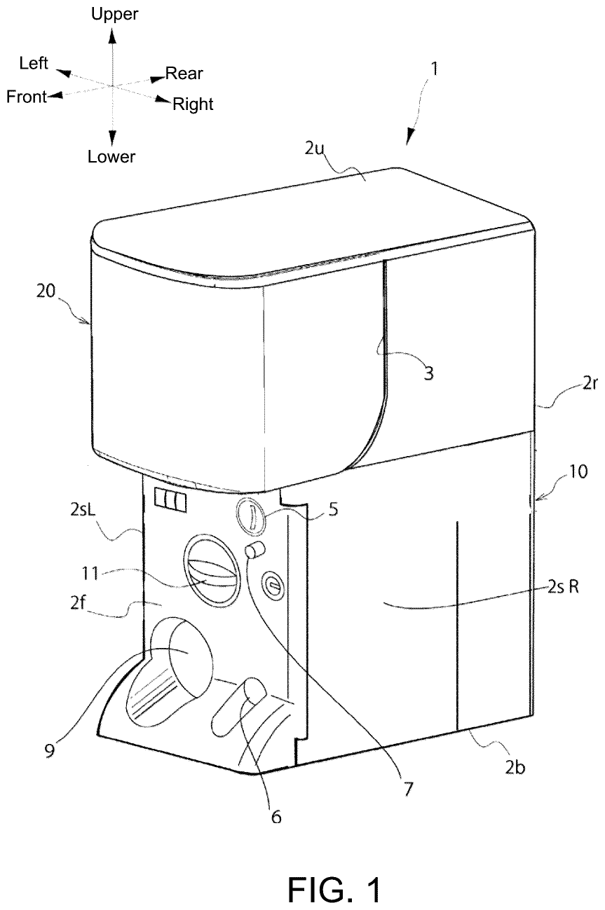

An embodiment of the present invention will be explained below referring to the figures. FIG. 1 is a perspective view showing an external appearance of an article supply apparatus according to the embodiment of the present invention.

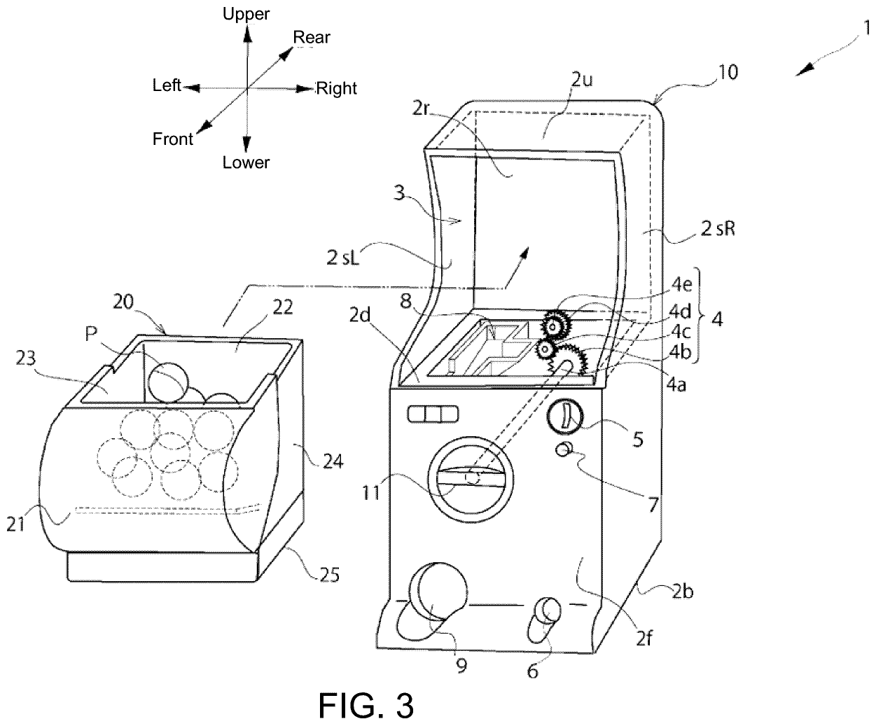

As shown in FIG. 1, the article supply apparatus 1 has a main body portion 10 in a box shape made up of a front wall 2f, a right side wall 2sR, a left side wall 2sL, a rear wall 2r, an upper wall 2u, and a bottom wall 2b, and various operation parts are provided on the front wall 2f thereof. On the front wall 2f, for example, a currency feeding port 5 capable of feeding consideration for an article P, a supply port 9 from which an article is discharged, a second operation part 11 of an operation portion for making it possible to supply the article P from the supply port 9 by performing a rotational operation thereof, a return port 6 for returning cash as needed, and a currency return button 7. Additionally, an attachment section 3 (refer to FIG. 3) is formed on an upper side of the front wall 2f. The attachment section 3 has a large opening on a front face side thereof and a front face upper side thereof. Further, the attachment section 3 is configured so that the accommodation unit 20, which accommodates articles P, can be attached to the attachment section 3 and detached therefrom.

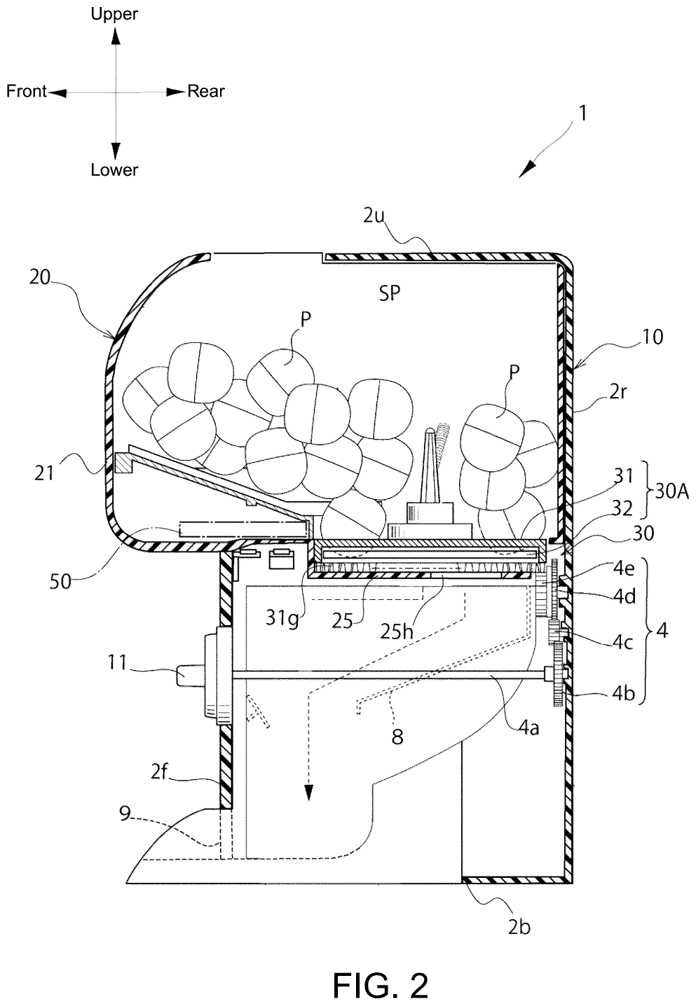

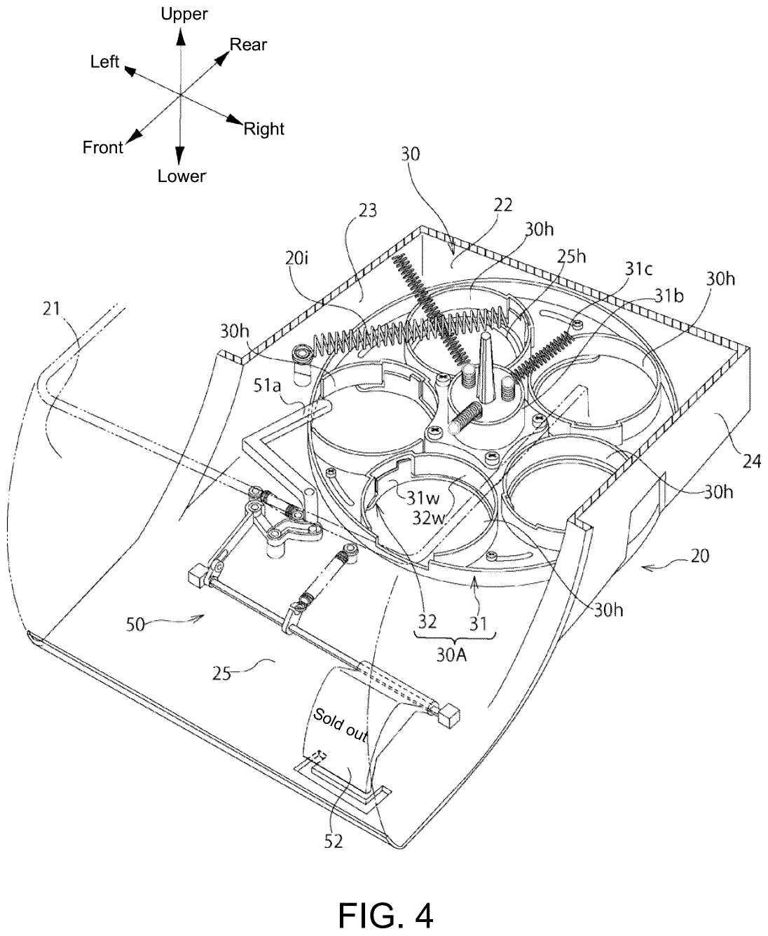

FIG. 2 is a vertical sectional view of the article supply apparatus 1, taken along a front-rear direction thereof. As shown in FIG. 2, the article accommodating unit 20, which has a storage space SP capable of accommodating a large number of articles P in a non-aligned state, is provided in the main body portion 10 of the article supply apparatus 1. On a bottom wall portion 25 of the article accommodating unit 20, an article supply unit 30 (see FIG. 4) having a turntable 30A including first and second turntable, which is rotationally operated, is provided. By this article supply unit 30, one article P is selected randomly from those in the article accommodating unit 20 and supplied. In this embodiment, the terms “article P” refer to a capsule-shaped container formed, for example, from synthetic resin material with appropriate rigidity. A toy or the like is enclosed in each of the articles P, which are configured to be easily rollable by itself. Therefore, since the articles P are configured to have a readily rollable spherical shape, they can be supplied to the user's hand from the article supply apparatus 1 while avoiding separation or damage thereof in the supply path.

Furthermore, the article supply apparatus 1 is equipped with a mechanism for locking the operation of the article supply unit 30, the second operation part 11 operable to release the lock conditionally upon payment of the price inserted from the currency feeding port 5 and to rotate the article supply unit 30, and a supply path 8 capable of allowing an article P to pass through from the article supply unit 30 to the supply port 9 by rolling. Moreover, on the rear wall 2r side, a gear mechanism 4 (gears 4b, 4c, 4d, 4e) capable of engaging with a rack gear 31g of the turntable 30A is provided. The second operation part 11 operable from the outside of the main body portion 10 is connected to a connecting shaft 4a, which is connected to this gear mechanism 4. Therefore, by a rotational operation of the second operating part 11, the turntable 30A of the article supply unit 30 (first turntable 31 and second turntable 32) is horizontally rotated.

FIG. 3 is a perspective view of the article supply apparatus 1, wherein the article accommodating unit 20 is removed therefrom. As shown in FIG. 3, the article accommodating unit 20 is a box-shaped accommodation case with an opening on an upper side, and has a front wall portion 21, a rear wall portion 22, a left side wall portion 23, a right side wall portion 24, and a bottom wall portion 25. And a third hole portion 25h capable of corresponding to article holding holes 30h of the turntable 30A, is provided on the bottom wall portion 25 side and a left rear side thereof. The article holding hole 30h and the third hole portion 25h will be described later. Additionally, below an attachment base 2d of the attachment section 3, a supply path 8 for supplying an article P to the supply port 9 is provided on a left rear side thereof. This supply path 8 has an open on an upper end side thereof. Therefore, when the article accommodating unit 20 is attached to the attachment section 3, an article P dropped from the third hole portion 25h is guided into the supply path 8 and discharged to the supply port 9.

FIG. 4 is a perspective view of the article accommodating unit 20 showing the inside thereof. As shown in FIG. 4, the bottom wall portion 25 of the article accommodating unit 20 is configured to have a lower face, forming a step on a rear side thereof (see FIG. 2), and the article supply unit 30 having a disc-shaped turntable 30A is arranged thereon so as to fit in this lower face. This turntable 30A includes, for example, the first turntable 31 arranged on an upper side thereof and having a circular rack gear 31g (see FIG. 2) at a lower end of an outer peripheral edge thereof, and the second turntable 32 arranged below the first turntable 31 and inside the rack gear 31g. This turntable 30A is provided with, for example, five article holding holes 30h arranged in the rotational direction. Additionally, on the bottom wall portion 25 of the article accommodating unit 20, as mentioned earlier, the third hole portion 25h is provided near the left side wall portion 23 and the rear wall portion 22. When an article P is supplied, the article P passes through one of the article holding holes 30h and drops downward through the third hole portion 25h to be supplied to the supply port 9.

In addition, a central protrusion part 31b projects upward from the center of the first turntable 31, and an agitating member 31c, which comprises a spring member capable of randomly agitating the accommodated articles P is provided. Further, above the third hole portion 25h, a spring member 20i is provided to prevent other articles P from interfering with the article P held in the article holding hole 30h.

Here, in the article supply unit 30, a lock mechanism 50 for preventing rotation of the article supply unit 30 when the articles P run out, is provided as shown in FIG. 4, in addition to the lock mechanism, which exerts by payment of consideration. For example, a tip portion of a locking arm 51a of the lock mechanism 50 arranged at a position on the front side of the bottom wall portion 25 of the article accommodating unit 20 advances into the article holding hole 30h and catches the first hole portion 31h, thereby locking the rotation of the first turntable 31 when the articles P run out. At this time, a plate portion 52 indicating “Sold out” descends in front of the currency feeding port 5 to prevent coin insertion.

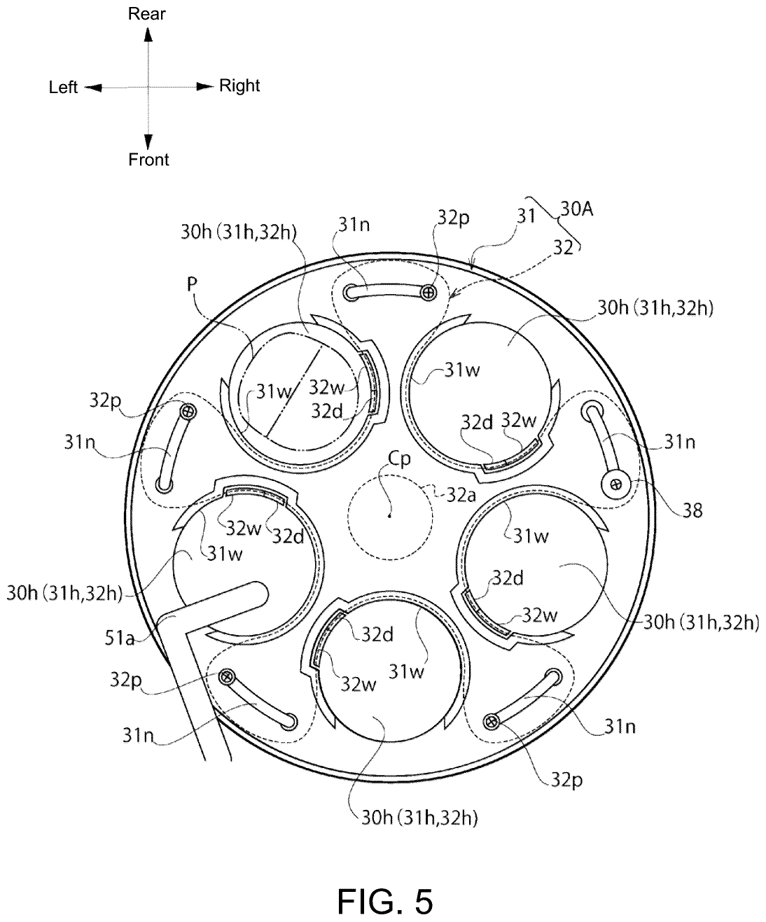

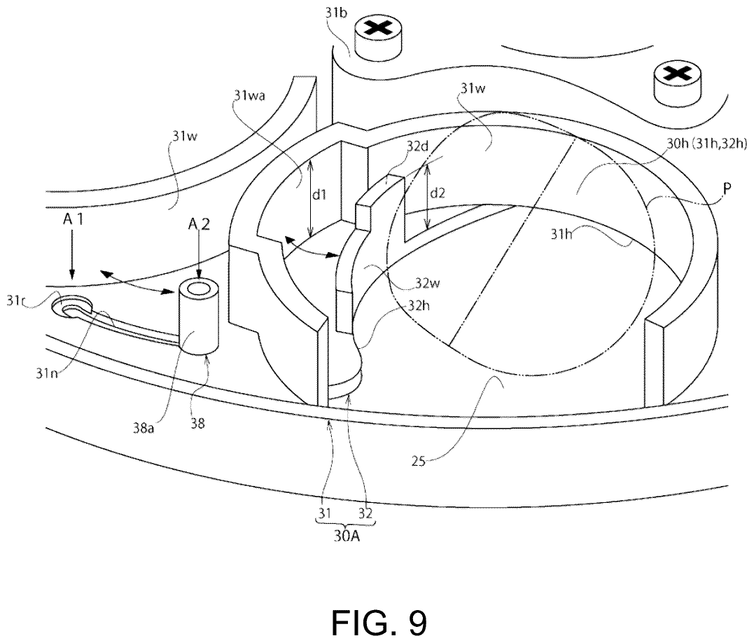

FIG. 5 is a schematic plan view of a turntable 30A of the article supply unit 30 viewed from above. As shown in FIG. 5, the first turntable 31 of the turntable 30A is rotatably provided with respect to its center point Cp. The circular first hole portions 31h, whose number is, for example, five, are provided around the center point Cp. A first peripheral wall 31w (see FIGS. 4 and 9), which projects upward in the thickness direction of the turntable 30A, is provided along the edge of each of the first hole portions 31h. Further, on a lower end side of the outer peripheral edge of the first turntable 31, the rack gear 31g (see FIG. 2) is provided as described above, so that the first turntable 31 can be rotated and driven.

The second turntable 32 is configured so that the relative position of the second turntable 32 with respect to the first rotatory table 31 in the circumferential direction can be changed around the center point thereof. For example, the second turntable 32 has a circular center hole 32a at its center, and a rotation support shaft of the first rotatory table 31 passes through this center hole 32a so that the second turntable 32 is supported thereby so as to be relatively rotatable. Further, a plurality of elongated holes 31n in an arc-shape are formed in a side of the outer peripheral edge of the first turntable 31 along an outer edge thereof. An outer peripheral portion of the second turntable 32 is supported by guide pins 32p, which respectively penetrate the respective elongated hole 31n (see FIGS. 5-7).

Each of the guide pins 32p engages with and is movable along one of the elongated holes 31n, and a tip portion of each guide pin 32p, which protrudes from the elongated hole 31n, has a diameter larger than the hole width of the elongated hole 31n.

Here, the article holding hole 30h is formed by overlapping the first hole portion 31h of the first turntable 31 with the second hole portion 32h of the second turntable 32, which is provided on a lower side of the first hole portion 31h. In a state shown in FIG. 5, the first hole portion 31h is the largest in size as the size of the article holding hole 30h, thereby forming the maximum diameter thereof so that the largest article P can be held.

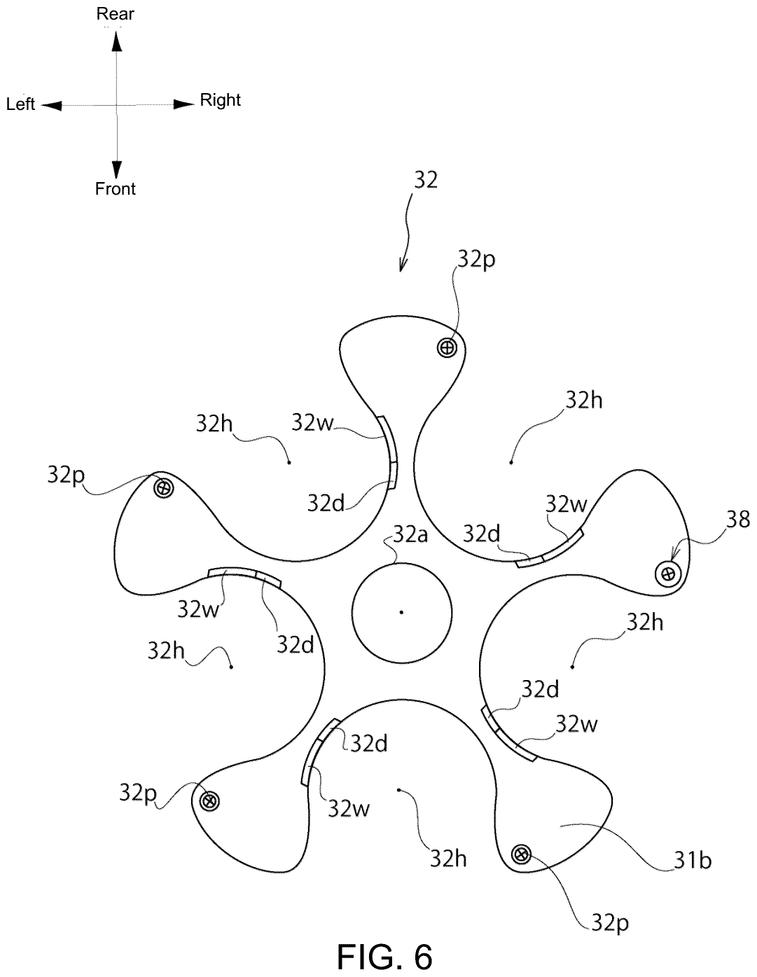

FIG. 6 is a plan view of the second turntable 32 of the article supply apparatus 30 viewed from above. As shown in FIG. 6, the second turntable 32 has five substantially circular cut-out portions surrounding the center hole 32a, each of which forms a second hole portion 32h. The second turntable 32, which is configured as such, has an outer periphery length longer than the outer periphery length of the first turntable 31. By forming the cut-out portions in the second hole portions 32h of the second turntable 32, it is possible to avoid catching when dropping the article P, compared to case where such cut-out portions are not formed, and to reduce friction between the first turntable 31 and the second turntable 32 when changing the relative position of the second turntable 32 with respect to the first turntable 3. Further, by arranging the second turntable 32 below the first turntable 31, it is possible to reliably guide the article P in the horizontal direction toward the third hole portion 25h by a frame portion of the first hole portion 31h of the first turntable 31 where no cut-out portions is formed (See FIGS. 2 and 4). Further, along an edge portion of the second hole portion 32h, a second peripheral wall 32w projecting upward in a thickness direction thereof is provided (See FIGS. 4 and 9). Furthermore, on the outer peripheral edge side, four guide pins 32p and one first operation part 38 are provided protruding upward in the thickness direction of the second turntable 32. The first operation part 38 is larger than each of the guide pins 32p and is of a size that can be operated by hand. The first operation part 38 can be operated in a state where at least part of the article accommodating unit 20 is removed from the main body portion 10 (in the state shown in FIG. 3).

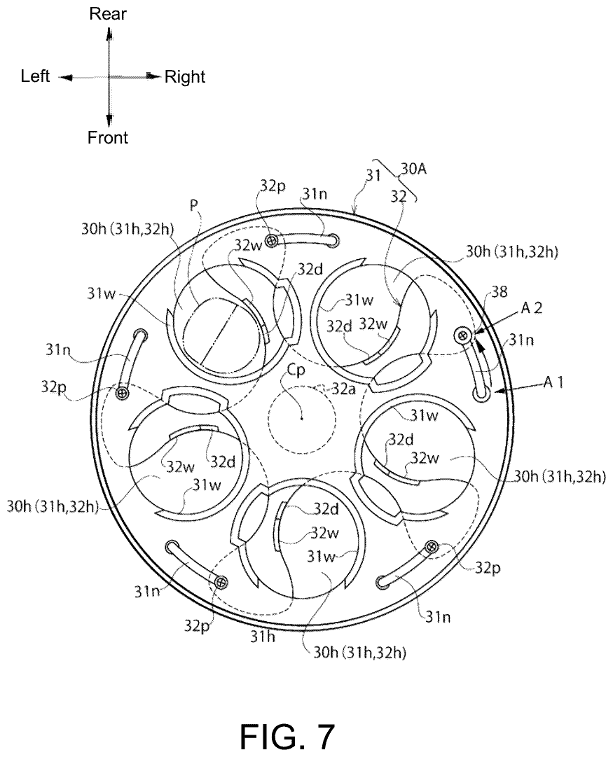

FIG. 7 is a schematic plan view of the turntable 30A of the article supply unit 30, showing a minimum opening state of the article holding holes 30h in the turntable 30A of the article supply unit 30. The first turntable 31 and the second turntable 32 are in a state where, as shown in FIG. 7, the second turntable 32 is relatively rotated counterclockwise with respect to the first turntable 31. In this state, the position of the first hole portion 31h and that of the second hole portion 32h are shifted from each other so that the article holding holes 30h are made smaller.

In an operation for changing this relative position, a user grasps the first operation part 38, and moves the second turntable 32 relative to the first turntable 31. That is, as shown in FIG. 7, when the second turntable 32 is moved from a first position A1 of the elongated hole portion 31n to a second position A2 (moving in a counterclockwise direction), the article holding holes 30h change from a state of a large perfect circle (as shown in FIG. 5), to a state where one end of the perfect circle is closed by an edge of the second hole portion 32h so that the holes becomes small. In such case, each article P which can be held by each of the small article holding hole 30h can be smaller than that of the articles P shown in FIG. 5. Thus, the size of the article holding holes 30h can be changed according to the size of the articles P accommodated in the article accommodating unit 20.

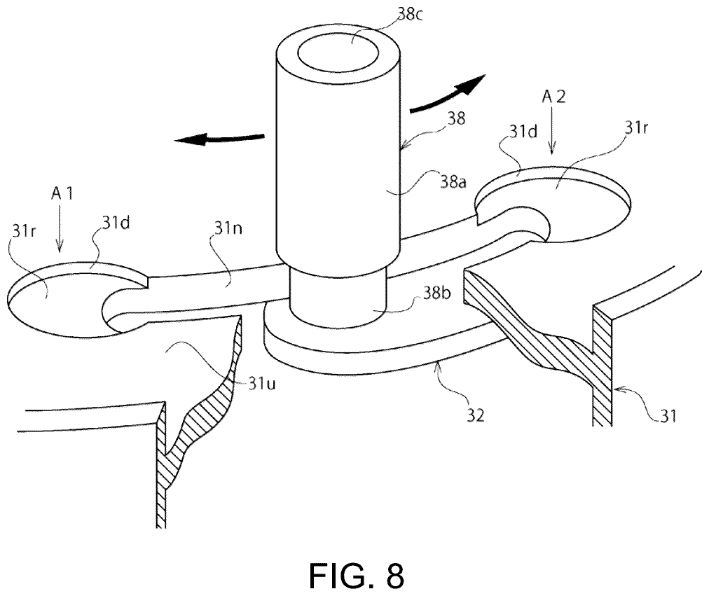

FIG. 8 is an enlarged perspective view of the first turntable 31 and the first operation part 38 formed on the second turn table 32, wherein part of the first turntable 31 is removed to show the first operation part 38 and the elongated holes 31n. The first operation part 38, as described above, is projected in the thickness direction of the second turntable 32, and as shown in FIG. 8, for example, the first operation part 38 is entirely cylindrical. The first operation part 38 has a small diameter at its base portion, and has a sliding engagement portion 38b which can slidably fit into the elongated hole portion 31n, and an operating gripping portion 38a having a large diameter at the upper end side of the first operation part 38 protrudes from an upper surface 31u of the first turntable 31. Furthermore, regarding the attachment structure, the first operation part 38 is attached to the second turntable 32, for example, by a screw passing through a through hole 38c.

At both ends of the elongated hole portion 31n in a longitudinal direction thereof, substantially circular locking portions 31r are formed so as to be lower than the upper surface 31u of the first turntable 31 with step portions 31d. The diameter of these locking portions 31r is slightly larger than the outer shape of the operating gripping portion 38a. Consequently, when the first operation part 38 is moved to one of the both ends of the elongated hole portion 31n, the lower end portion of the operating gripping portion 38a is fit in the locking portion 31r so as to be engaged therewith. That is, at the first position A1 where the article holding holes 30h are maximized, the first operation part 38 is engaged with and held by the left-side locking portion 31r as shown in FIG. 8, and at the second position A2 where the article holding holes 30h are minimized, the first operation part 38 is engaged with and held by the right-side locking portion 31r. Therefore, the first turntable 31 and the second turntable 32 rotate integrally, that is, without any relative movement, when the second operating part 11 is operated to be rotated and driven. Additionally, as the engagement structure of the four guide pins 32p and the elongated hole portions 31n, locking portions are similarly formed at both ends of each of the elongated hole portions 31n.

Here, a force for the operating gripping portions 38a to fit in the locking portions 31r is set so that the operating gripping portion 38a may fit in the locking portions 31r, for example, by the gravity. Therefore, the operating gripping portion 38a can be disengaged from the locking portions 31r, by pulling the operating gripping portion 38a upward.

Furthermore, the first operation part 38 may be configured to exert a bias toward the side of the first turntable 31 with an appropriate elastic force in its axial direction. In this case, for example, an elastic member such as a coil spring is provided on the inner side of the screw provided in the through hole 38c, that is, between the head of the screw and the bottom portion of the through hole 38c, to allow a movement in the axial direction. Thus, the operating gripping portion 38a is attached thereto to press against the upper surface 31u of the first turntable 31.

FIG. 9 is an enlarged perspective view of the first hole portion 31h and the second hole portion 32h, showing a state in which the first hole portion 31h and the second hole portion 32h overlap each other. As mentioned above, the second peripheral wall 32w is formed on the edge of each of the second hole portions 32h formed in the second turntable 32. As shown in FIG. 9, a protruding wall 32d is formed on his second peripheral wall 32w so as to protrude higher than the second peripheral wall 32w. Since the second peripheral wall 32w and the protruding walls 32d are provided, when the position of the second turntable 32 is shifted so that the size of the article holding holes 30h become small, the second peripheral wall 32w, the protruding walls 32d and the first peripheral wall 31w serve as members which regulate the position of article P within the article holding hole 30h. That is, the position of the article P is regulated within the article holding hole 30h and the regulated article P is held in the article holding hole 30h, so as to be brought in contact with the bottom wall portion 25 of the article accommodating unit 20, except where the third hole portion 25h is formed, and are rotated and moved together with movement of the turntable 30A.

Furthermore, the protruding height (d2) of the protruding walls 32d is configured to be smaller than the protruding height (d1) of the first peripheral wall 31w. That is, a peripheral wall recess 31wa is formed in the first peripheral wall 31w, wherein the peripheral wall recess 31wa is recessed in a direction where a hole diameter thereof becomes larger. The second peripheral wall 32w and protruding walls 32d are configured to fit into the peripheral wall recess 31wa. Thus, when the second peripheral wall 32w and the protruding walls 32d are positioned within the peripheral wall recess 31wa (when the first hole portion 31h is not closed by the second turntable 32), the second peripheral wall 32w and the protruding walls 32d are brought in contact with the inside of the peripheral wall recess 31wa and do not protrude from the first peripheral wall 31w. This allows the article holding hole 30h to be configured larger.

As described above, in the article supply apparatus 1 according to the present embodiment, the first turntable 31 and the second turntable 32, which can overlap each other to form the article holding holes 30h for holding and allowing passage of the articles P, are configured so that the relative position of the second turntable 32 with respect to the first turntable 31 may be changed by an operation of the first operation part 38, thereby changing the size of the article holding holes 30h. Thus, since the second hole portion 32h of the second turntable 32 is positioned so as to overlap the first hole portion 31h of the first turntable 31 on a downstream side thereof in a passage direction of the article P, the holes thereof can be formed by overlapping the second hole portion 32h and the first hole portion 31h with each other, and changing the relative position of the second hole portion 32h with respect to the first hole portion 31h. Furthermore, since each of the second hole portions 32h is configured in a notched shape, it is easy to change the size of the holes by closing part of the first hole portion 31h.

Moreover, since the second turntable 32 is configured so that the relative position thereof with respect to the first turntable 31 may be changed according to the size of the articles P accommodated in the article accommodation unit, 20 by operating the first operation part 38, it is possible to appropriately set the size of the article holding holes 30h corresponding to the size of the articles P. Furthermore, since the first turntable 31 and the second turntable 32 are integrally and rotatably locked with each other by an operation of the second operating part 11, they function as a single turntable 30A.

Furthermore, in the article supply apparatus 1 according to the present embodiment, since the first operation portion 38 is provided inside the article accommodation unit 20, the first operation part 38 is only operable when the article accommodation unit 20 is detached from the main body portion 10, and cannot be operated by general users. On the other hand, the second operation part 11 is provided on the outside of the main body portion 10, for example, on the front wall 2f, thereby allowing an operation by such general users.

Additionally, since the first hole portion 31h has the first peripheral wall 31w, which forms the edge of the first hole portion 31h, and the second hole portion 32h also has the second peripheral wall 32w, which forms part of the edge of the second hole portion 32h, it is easy for the end faces of both peripheral walls 31w, 32w to approach or be brought in contact with each other, so that the formed holes can be integrally configured.

In the article supply apparatus 1 according to the present embodiment, the first peripheral wall 31w is configured so as to be taller than the second peripheral wall 32w, thereby making it easier, for example, to form an area with which the protruding walls 32d of the second peripheral wall 32w is brought in contact. Furthermore, since the protruding walls 32d are configured so as to be brought in contact with the respective first peripheral walls 31w, positioning of the second peripheral walls 32w with respect to the respective first peripheral walls 31w may be facilitated. Moreover, by the locking portions 31r of the first operation part 38, the relative positions between both turntables 31, 32 can be fixed, so that the articles P can be stably supplied according to the size thereof.

Moreover, in the article supply apparatus 1 according to the present embodiment, the first operation part 38 connected to the second turntable 32 can be guided and moved by the arc-shaped elongated hole portion 31n along the rotation direction of the first turntable 31, and the first operation part 38 can be locked at either the position A1 or A2 in the elongated hole portion 31n, so that the set size of the article holding holes 30h may be maintained.

While one embodiments of the present invention has been described above, it is possible to appropriately modify the present invention within the scope of its technical concept. For example, in the above embodiment, the five article holding holes 30h are provided, but this configuration is not limited thereto, and for example, a configuration with four holes may also be suitable.

Moreover, in the above embodiments, the relative positions of the first turntable 31 and the second turntable 32 are locked at the two locations, but the configuration is not limited thereto, and it may be locked at an intermediate position of the elongated hole portion 31n to accommodate other sizes of articles (or to sort sizes of articles).

As described above, matters as set forth below are disclosed in this specification.

(1) An article supply apparatus comprises a main body, an article accommodating unit provided in the main body for accommodating articles, an article supply unit, which is provided in the article accommodating unit and includes a first turntable and a second turntable, and a first operating unit provided in the article supply unit, wherein the second turntable is configured so that the relative position with respect to the first turntable can be changed by an operation of the first operating unit.

(2) In the article supply apparatus according to (1), the second turntable is configured so that the relative position of the second turntable with respect to the first turntable can be changed according to the size of the articles accommodated in the article accommodation unit.

(3) In the article supply apparatus according to either (1) or (2), a second operating unit which operates the article supply unit is provided in the main body, wherein the first turntable and the second turntable are configured to be rotatable in an integrated fashion according to an operation of the second operating unit.

(4) In the article supply apparatus according to (3), the first operating unit is provided inside the article accommodation unit, and the second operating unit is provided outside the main body.

(5) In the article supply apparatus according to any one of (1)-(4), a plurality of first hole portions in shape of a perfect circle are formed in the first turntable, through which the articles accommodated in the article accommodation unit may pass.

(6) In the article supply apparatus according to (5), a second hole portion, though which one of the articles passes after passing through one of the first hole portions, is formed in the second turntable.

(7) In the article supply apparatus according to (6), each of the second hole portions are a cut-out part which is formed by cutting out part of the second turntable.

(8) In the article supply apparatus according to (7), the first turntable has a shorter outer periphery length than that of the second turntable.

(9) In the article supply apparatus according to any one of (6)-(8), the second turntable is configured to close at least part of the first hole portion by a relative movement thereof with respect to the first turntable.

(10) In the article supply apparatus according to (9), each of the first hole portions has a first peripheral wall constituting an edge portion thereof, and each of the second hole portions has a second peripheral wall constituting an edge portion thereof, and a height of the first peripheral wall is higher than that of the second peripheral wall.

(11) In the article supply apparatus according to (10), the second peripheral wall has a protruding wall, and the protruding wall is brought in contact with the first peripheral wall in a state where the first hole portion is not closed.

(12) In the article supply apparatus according to any one of (5)-(11), an elongated hole is formed in a portion except where the first hole portion is formed, and the first operation part is configured so as to be movable in the elongated hole.

(13) In the article supply apparatus according to (12), the elongated hole is arc-shaped, and the second turntable does not close the first hole portion when the first operation part is located at a first position of the elongated hole, and the second turntable closes part of the first hole portion when the first operation part is located at a second position.

(14) In the article supply apparatus according to (13), the article supply unit is configured so that a first size article and a second size article, which is smaller than the first size article, can be supplied, and so that the first size article can be supplied when the first operation part is at the first position, the second size article can be supplied when the first operation part is at the second position.

(15) In the article supply apparatus according to any one of (5)-(14), the first turntable and the second turntable are configured so as not to change a relative position thereof in a rotational driving state thereof.

(16) In the article supply apparatus according to any one of (5)-(15), the first operation part includes a locking portion, which performs a lock operation so that the relative position of the first turntable with respect to the second turntable is not changed.

(17) In the article supply apparatus according to (16), the second turntable is configured to change a relative position thereof with respect to the first turntable, when the lock operation performed by the locking portion is released.

(18) In the article supply apparatus according to any one of (5)-(17), the second turntable selects the articles which can pass through the first hole portion by closing part of the first hole portion.

(19) In the article supply apparatus according to any one of (5)-(18), the article accommodation unit is provided detachably from the main body, and the first operation part is configured to be operable in a state where at least part of the article accommodation unit is detached from the main body.

(20) In the article supply apparatus according to any one of (1)-(19), the article supply unit includes a bottom portion of the article accommodation unit, and a third hole portion through which one of the article passes through is formed in the bottom portion.

(21) In the article supply apparatus according to (20), the first turntable and the second turntable hold the articles, which are in contact with the bottom portion, so as to be movable according to rotation thereof.

(22) In the article supply apparatus according to either (20) or (21), the article accommodation unit includes a front wall, a rear wall, a right side wall, and a left side wall, and the third hole portion is formed adjacent to the left side wall and the rear side wall.

1. An article supply apparatus, comprising:
a main body;
an article accommodating unit provided in the main body, accommodates articles;
an article supply unit provided in the article accommodating unit and including a first turntable and a second turntable; and
a first operating unit provided in the article supply unit,
wherein a relative position of the second turntable with respect to the first turntable is changed by an operation of the first operating unit.

2. The article supply apparatus according to claim 1, wherein the first turntable and the second turntable are configured so that the relative position of the second turntable with respect to the first turntable can be changed according to a size of the articles accommodated in the article accommodation unit.

3. The article supply apparatus according to claim 2, wherein a second operation unit which operates the article supply unit is provided in the main body, and the first turntable and the second turntable are configured to be rotatable in an integrated fashion according to an operation of the second operating unit.

4. The article supply apparatus according to claim 3, wherein the first operating unit is provided inside the article accommodation unit, and the second operating unit is provided outside the main body.

5. The article supply apparatus according to claim 4, wherein a plurality of first hole portions are formed in the first turntable, through which the articles accommodated in the article accommodation unit may pass.

6. The article supply apparatus according to claim 5, wherein a second hole portions, though which the articles pass after passing through the first hole portions, are formed in the second turntable.

7. The article supply apparatus according to claim 6, wherein each of the second hole portions is configured as a cut-out part which is formed by cutting out part of the second turntable.

8. The article supply apparatus according to claim 7, wherein the first turntable has an outer periphery length shorter than that of the second turntable.

9. The article supply apparatus according to claim 6, wherein the second turntable is configured to close part of the first hole portion by a relative movement of the second turntable with respect to the first turntable.

10. The article supply apparatus according to claim 9, wherein the first hole portion includes a first peripheral wall constituting an edge portion of the first hole portion, and the second hole portion includes a second peripheral wall constituting an edge portion of the second hole portion, and a height of the first peripheral wall is higher than that of the second peripheral wall.

11. The article supply apparatus according to claim 10, wherein the second peripheral wall includes a protruding wall, and the protruding wall is brought in contact with the first peripheral wall in a state where the first hole portion is not closed.

12. The article supply apparatus according to claim 5 wherein an elongated hole is formed in a portion, except where the first hole portion is formed, and the first operation part is configured to be movable in the elongated hole.

13. The article supply apparatus according to claim 12, wherein the elongated hole is arc-shaped, and the second turntable does not close the first hole portion when the first operation part is located at a first position of the elongated hole, and the second turntable closes part of the first hole portion when the first operation part is located at a second position.

14. The article supply apparatus according to claim 13, wherein the article supply unit is configured so that a first size article and a second size article, which is smaller than the first size article, can be supplied, and so that the first size article can be supplied when the first operation part is at the first position, the second size article can be supplied when the first operation part is at the second position.

15. The article supply apparatus according to claim 5, wherein, the first turntable and the second turntable are configured so as not to change a relative position thereof during rotational driving.

16. The article supply apparatus according to claim 5, wherein the first operation part includes a locking portion, which performs a lock operation so that the relative position of the first turntable with respect to the second turntable is not changed.

17. The article supply apparatus according to claim 16, wherein the second turntable is configured to change the relative position of the second turntable with respect to the first turntable, when the lock operation performed by the locking portion is released.

18. The article supply apparatus according to claim 5, wherein the second turntable selects one of the articles which can passes through the first hole portion by closing part of the first hole portion.

19. The article supply apparatus according to claim 5, wherein the article accommodation unit is provided detachably from the main body, and the first operation part is configured to be operable in a state where at least part of the article accommodation unit is detached from the main body.

20. The article supply apparatus according to claim 5, wherein, the article supply unit includes a bottom portion of the article accommodation unit, and a third hole portion through which one of the articles passes through is formed in the bottom portion.
